(19) United States
(12) Patent Application Publication
(10) Pub. No.: US 2026/0321783 A1
(43) Pub. Date: Oct. 15, 2026

(54) POWER STORAGE DEVICE

(71) Applicant: TOYOTA JIDOSHA KABUSHIKI KAISHA, Toyota-shi (JP)

(72) Inventors: Takaaki MATSUI, Seto-shi (JP); Taichi KATSUMOTO, Nagakute-shi (JP); Akinori KOKUBO, Toyohashi-shi (JP)

(21) Appl. No.: 19/464,614

(22) Filed: Jan. 30, 2026

(30) Foreign Application Priority Data
Mar. 26, 2025 (JP) 2025-052549

(51) Int. Cl. H01M 10/6555; H01M 10/613; H01M 10/647; H01M 50/209; H01M 50/242; H01M 50/291

(52) U.S. Cl. CPC H01M 10/6555; H01M 10/613; H01M 10/647; H01M 50/209; H01M 50/242; H01M 50/291

(57) ABSTRACT

A cell case has a first plate part which receives force from the spacer in a first direction, and a second plate part which contacts a heat conductive material in a second direction orthogonal to the first direction, and an area of a part of the spacer which exerts force on the first plate part as viewed along the first direction is smaller than an area of the first plate part.

### CROSS-REFERENCE TO RELATED APPLICATION

This application is based on and claims priority under 35 USC 119 from Japanese Patent Application No. 2025-052549, filed on Mar. 26, 2025, the disclosure of which is incorporated by reference herein.

### BACKGROUND

### Technical Field

The present disclosure relates to a power storage device.

### Related Art

Japanese Patent Application Laid-open No. 2012-124319 discloses a power storage device including plural battery cells layered in a predetermined direction, and plural spacers provided between adjacent battery cells.

A battery module having plural battery cells and plural spacers and in which the battery cells and the spacers are restrained by the restraining member is housed in a battery case (lower case), and the bottom of the battery cells and the bottom of the battery case can be connected by a heat conductive material having an adhesive force. In this way, the heat of the battery cells can be transmitted to the battery case via the heat conductive material.

Incidentally, a difference between the shape of the contact part with the heat conductive material of the battery cell when placing the battery cell on the heat conductive material and the shape of the contact part when the battery cell is charged is likely to occur. When this difference becomes large, the battery cells are likely to become separated from the heat conductive material when the battery cells are charged.

In view of the above circumstances, it is an object of the present disclosure to obtain a power storage device capable of suppressing peeling of a battery cell from a heat conductive material in a case in which a battery module having plural battery cells and spacers restrained by a restraining member is connected to a battery case provided with a cooler using a thermally conductive material having adhesive force,

### SUMMARY

A power storage device according to a first aspect includes: plural battery cells having a cell case accommodating an electrode body and provided aligned in a predetermined first direction; a spacer provided between adjacent battery cells, and exerting force on the cell case in the first direction; a restraining member exerting an external force on the battery cells and the spacer; a battery case accommodating a battery module having the battery cells, the spacer, and the restraining member; a cooler connected to the battery case; and a heat conductive member that is adhered to the cell case and the battery case and that transmits heat from the cell case to the cooler via the battery case, in which: the cell case has: a first plate part that receives force from the spacer in the first direction; and a second plate part that contacts the heat conductive member in a second direction orthogonal to the first direction, and an area of a portion of the spacer that exerts force on the first plate part, as viewed along the first direction, is smaller than an area of the first plate part.

In the power storage device of the first aspect, an external force is applied from the spacer to the first plate part of the cell case of the battery cell. As a result, at a time point before the second plate part of the cell case contacts the heat conductive material, the second plate part tends to protrude toward the outside of the cell case.

However, the area of the part of the spacer which exerts force on the first plate part as viewed in the first direction is smaller than the area of the first plate part. In other words, the spacer does not exert a force on the entire first plate part, and a portion of the first plate part becomes a non-pressure-receiving region which does not receive force from the spacer. As a result, when the spacer exerts external force on the first plate part of the cell case, the non-pressure-receiving region becomes a relief field for stress generated at the first plate part. As a result, the amount of protuberance of the second plate part toward the outside of the cell case is smaller than in a case in which the non-pressure-receiving region is not present in the first plate part.

The second plate part, which is in an outwardly protruding state, is connected to the battery case via the heat conductive material. When the battery cell is charged in this state, the second plate part is deformed so as to be recessed toward the internal space side of the cell case. However, since the amount of protuberance of the second plate part toward the outside of the cell case before charging is small, the amount of deformation of the second plate part before and after charging is unlikely to be large. As a result, there is little likelihood that the second plate part will be peeled from the heat conductive material.

A power storage device of a second aspect is the first aspect, in which the cell case is a rectangular parallelopiped-shaped case having a pair of the first plate parts, the second plate part, which is connected to one end part of the pair of first plate parts in the second direction, a third plate part connected to another end part of the pair of first plate parts in the second direction, and a pair of fourth plate parts connected to the first plate parts, the second plate part and the third plate part and orthogonal to the first plate parts, the second plate part and the third plate part.

In the power storage device of the second aspect, since the spacer exerts external force on the pair of first plate parts, the second plate part tends to protrude toward the outside of the cell case. However, in this case, since the non-pressure-receiving region becomes a stress relief field generated in the first plate part, the amount of protuberance of the second plate part toward the outside of the cell case is likely to be small as compared to a case in which no stress relief field is present in the first plate part.

A power storage device of a third aspect is the first aspect or the second aspect, in which the spacer exerts force on the first plate part while avoiding an end part of the first plate part at a side of the second plate part.

In the power storage device of the third aspect, the spacer does not exert force on the end part of the first plate part at the side of the second plate part. As a result, as compared to a case in which the spacer exerts force on the end part of the first plate part at the side of the second plate part, the amount of protuberance of the second plate part toward the outside of the cell case is likely to be small.

A power storage device of a fourth aspect is any one of the first to third aspects, in which the spacer, which is a single spacer, exerts force on the first plate part while avoiding both end parts of the first plate part in the second direction.

In the power storage device of the fourth aspect, when the spacer exerts external force on the first plate part of the cell case, both end parts of the first plate part in the second direction become stress relief fields. As a result, the amount of protuberance of the second plate part toward the outside of the cell case tends to be reduced.

A power storage device of the fifth aspect is any one of the first to third aspects, in which plural spacers, which are aligned at an interval in the second direction, exert force on a single one of the first plate parts while avoiding a central part of the first plate part in the second direction.

In the power storage device of the fifth aspect, when the spacer exerts external force on the first plate part of the cell case, a stress relief field is generated in the central part of the first plate part in the second direction. As a result, the amount of protuberance of the second plate part toward the outside of the cell case tends to be reduced.

As described above, the power storage device according to the present disclosure has an excellent effect of suppressing peeling of the battery cell from the heat conductive material in a case in which a battery module having plural battery cells and spacers restrained by a restraining member is connected to a battery case provided with a cooler using a thermally conductive material having adhesive force.

### BRIEF DESCRIPTION OF THE DRAWINGS

Exemplary embodiments of the present disclosure will be described in detail based on the following figures, wherein:

FIG. 1 is an exploded perspective view of a battery pack according to a first embodiment;

FIG. 2 is a schematic exploded perspective view of the lower case of the battery case and the battery module;

FIG. 3 is a schematic cross-sectional view of a battery cell and two spacers sectioned along a plane orthogonal to the front-rear direction;

FIG. 4 is a schematic cross-sectional view of a lower part of a cell case when a pair of end plates are drawn together by a restraining member;

FIG. 5 is a schematic cross-sectional view of the battery module, a heat conductive material, and a bottom plate part of the lower case;

FIG. 6 is a similar cross-sectional view to FIG. 5 at a time when the battery cell is charged;

FIG. 7 is a similar schematic cross-sectional view to FIG. 3 of the battery pack according to a second embodiment;

FIG. 8 is a similar schematic cross-sectional view to FIG. 3 of the battery pack according to a third embodiment; and

FIG. 9 is a similar schematic cross-sectional view to FIG. 3 of the battery pack according to a fourth embodiment.

### DETAILED DESCRIPTION

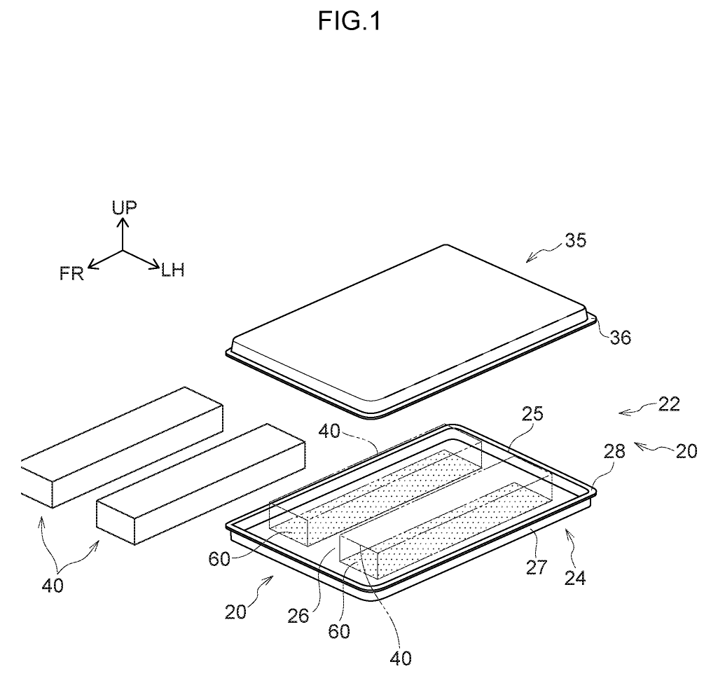

Hereinafter, a battery pack (power storage device) according to the first embodiment will be described with reference to FIGS. 1 - 6. Note that the arrows UP, FR, and LH in the drawings respectively indicate an upper side in the vehicle up-down direction (second direction), a front side in the vehicle front-rear direction (first direction), and a left side in the vehicle left-right direction.

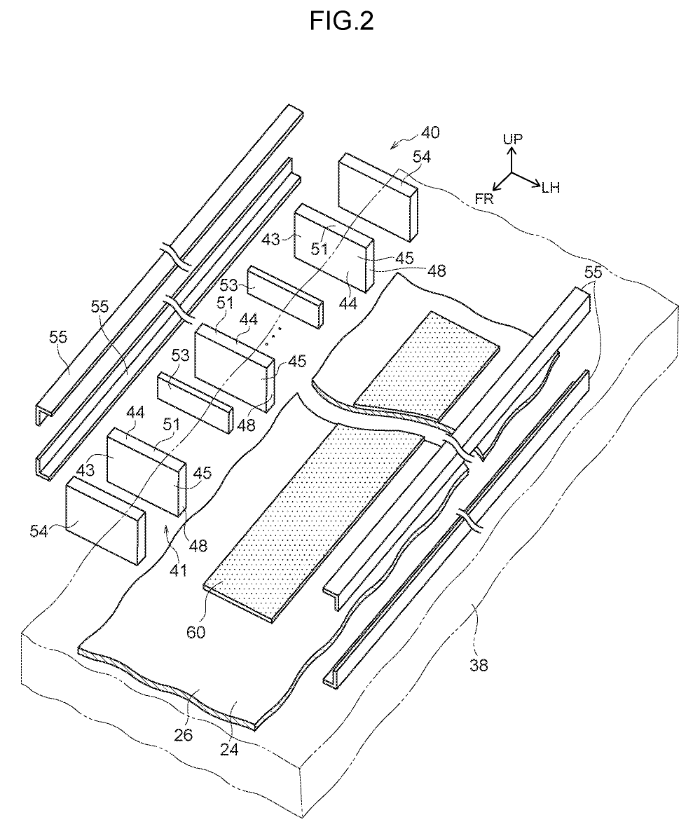

The battery pack 20 of the present embodiment shown in FIGS. 1 and 2 is installed in a vehicle. The vehicle of the present embodiment is a battery electric vehicle (BEV).

The battery pack 20 of the present embodiment has a battery case 22 and two battery modules 40. The power of the battery pack 20 (battery cell 43) is supplied to, for example, an electric motor (not illustrated) which applies a driving force to the front wheels and the rear wheels of the vehicle.

As shown in FIGS. 1 and 2, the battery case 22 has a lower case 24 and an upper case 35.

The lower case 24 is a hollow body having an opening 25 formed at an upper face thereof. The lower case 24 has a bottom plate part 26, a peripheral wall part 27, and an outer peripheral flange 28. The planar shape of the peripheral wall part 27 is annular, and the lower end part of the peripheral wall part 27 is connected to the outer peripheral edge part of the bottom plate part 26. The planar shape of the outer peripheral flange 28 is annular, and the inner peripheral edge part of the outer peripheral flange 28 is connected to the upper end part of the peripheral wall part 27. The lower case 24 is made, for example, of metal.

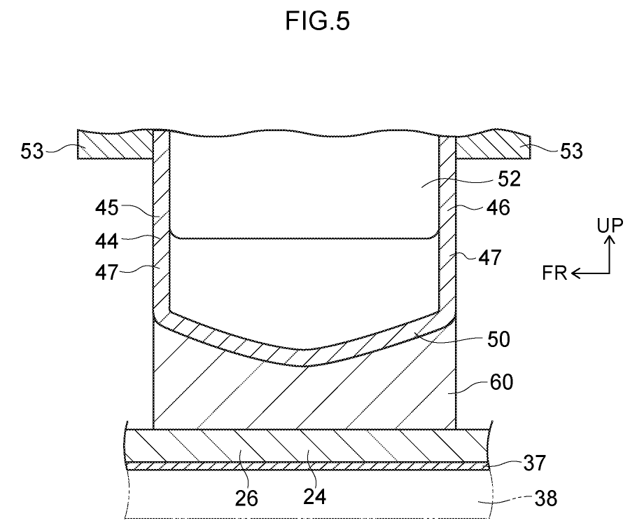

As shown in FIGS. 2 and 5, a cooler 38 is connected (affixed) to the lower surface of the bottom plate part 26 via a heat conductive material 37. A cooling liquid (not illustrated) circulates inside the cooler 38.

The upper case 35 is a hollow body having an opening formed at its lower surface. An outer peripheral flange 36 is provided at the lower end of the upper case 35.

As shown in FIG. 1, two battery modules 40 are provided inside the lower case 24. The battery modules 40 are aligned in the left-right direction.

As shown in FIG. 2, the battery module 40 includes a battery stack 41, a pair of end plates 54, and four restraining members 55.

The battery stack 41 extending in the front-rear direction in plan view includes plural battery cells 43 and plural spacers 53 positioned between adjacent battery cells 43. Note that although only three battery cells 43 are shown in FIG. 2 for convenience, in practice, the battery stack 41 has more than three battery cells 43.

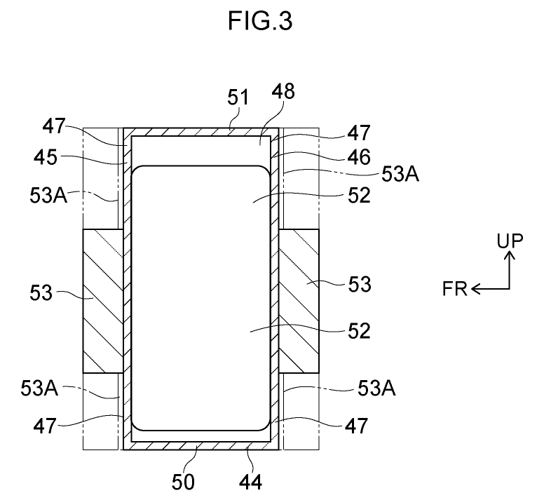

As shown in FIGS. 2 and 3, a metal cell case 44 configuring the outer shape of the battery cell 43, which is a lithium-ion battery, has a rectangular parallelepiped shape. Specifically, the cell case 44 includes a front plate part (first plate part) 45, a rear plate part (first plate part) 46, a pair of side plate parts (fourth plate part) 48, a bottom plate part (second plate part) 50, and an upper plate part (third plate part) 51. The front plate part 45 and the rear plate part 46 have substantially the same shape. The front shapes of the front plate part 45 and the rear plate part 46 are a rectangular shape having a larger lateral dimension than the vertical dimension. The lateral shapes of the left and right-side plate parts 48 are a rectangular shape having a larger vertical dimension than the front-rear dimension. The bottom plate part 50 and the upper plate part 51 have substantially the same shape. The planar shapes of the bottom plate part 50 and the upper plate part 51 are a rectangular shape having a larger left-right dimension than the front-rear dimension. Respective front and rear end parts of the left and right-side plate parts 48 are connected to the left and right-side edge parts of the front plate part 45 and the rear plate part 46, respectively. Respective left and right side edge parts of the bottom plate part 50 and the upper plate part 51 are connected to the respective upper and lower edge parts of the left and right side plate parts 48, respectively, and respective front and rear edge parts of the bottom plate part 50 and the upper plate part 51 are connected to respective upper and lower edge parts of the front plate part 45 and the rear plate part 46, respectively. The front plate part 45 and the rear plate part 46 are orthogonal to the front-rear direction, the side plate parts 48 are orthogonal to the left-right direction, and the bottom plate part 50 and the upper plate part 51 are orthogonal to the vertical direction. Furthermore, each battery cell 43 has a positive electrode and a negative electrode (neither of which is illustrated). Note that the entire surface of the cell case 44 is covered with an exterior film (not illustrated). In the following description, the exterior film is regarded as a part of the cell case 44. The exterior film adheres to the surface of the cell case 44 so as to avoid the positive electrode and the negative electrode.

As shown in FIG. 3, an electrode body 52 is provided in the internal space of each cell case 44. Furthermore, an electrolytic solution (not illustrated) is provided in the internal space of the cell case 44. The electrode body 52 is connected to the positive electrode and the negative electrode via a conductive member (not illustrated).

As shown in FIGS. 2 and 3, a spacer 53 is provided between adjacent battery cells 43 (cell cases 44). The spacer 53 (and the spacers 60, 70, 75 described later) is an integral molded product made of a resin. The spacer 53 (60, 70, 75) has electrical insulation, elasticity, and higher heat insulating properties than the cell case 44. The spacer 53 has a substantially rectangular parallelepiped shape. The left-right width of the spacer 53 is substantially the same as that of the battery cell 43, and the front-rear dimension of the spacer 53 is smaller than that of the cell case 44. Furthermore, the vertical dimension of the spacer 53 is smaller than that of the cell case 44. As shown in FIG. 3, each spacer 53 contacts a central part, in the vertical direction, of the front plate part 45 and the rear plate part 46 of the cell case 44 of the battery cell 43. Specifically, the upper part and the lower part of the front plate part 45 and the rear plate part 46 are non-pressure-receiving regions 47 at which the spacer 53 does not contact. The area of the spacer 53 (the portion in contact with the front plate part 45 or the rear plate part 46) as viewed in the front-rear direction is smaller than the area of the front plate part 45 and the rear plate part 46.

As shown in FIG. 2, the battery module 40 includes a pair of front and rear end plates 54. The front side end plate 54 is positioned immediately before the foremost battery cell 43, and the rear side end plate 54 is positioned immediately after the rearmost battery cell 43.

As shown in FIG. 2, the four restraining members 55 extend in the front-rear direction and have a substantially L-shaped cross-sectional shape. Each restraining member 55 is fixed to the front and rear end plates 54 while covering the four corners of each battery cell 43 (cell cases 44) and end plate 54, respectively. As a result, the front-rear length of each restraining member 55 becomes shorter than in the free state. Specifically, the front and rear end plates 54 are pulled toward each other by the restraining members 55, whereby the front and rear end plates 54 sandwich the battery stack 41 from the front and rear sides.

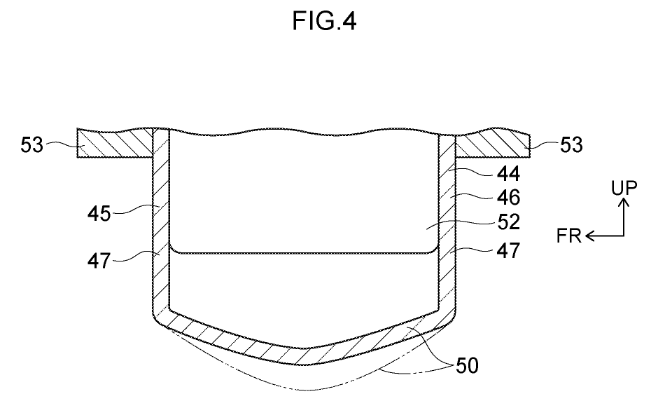

As a result, a cell case 44 and a spacer 53 that are adjacent to each other in the front-rear direction contact each other in the front-rear direction with a strong force. In other words, a force in the front-rear direction is exerted from each spacer 53 to the central part, in the vertical direction, of the front plate part 45 and the rear plate part 46 of the cell case 44. As a result, the vertical direction central part of the front plate part 45 and the rear plate part 46 is pushed toward the inner space side of the cell case 44. As a result, stress is generated in the front plate part 45 and the rear plate part 46, and this stress is transmitted from the front plate part 45 and the rear plate part 46 to the bottom plate part 50 and the upper plate part 51. Furthermore, along with the deformation of the cell case 44, the pressure (atmospheric pressure) in the internal space of the cell case 44 changes, and this pressure extends to the bottom plate part 50 and the upper plate part 51. As a result, as shown in FIG. 4, the bottom plate part 50 protrudes downward as compared to when it is in a free state. Further, while not shown, the upper plate part 51 expands upward as compared to when it is in a free state.

In this way, the battery stack 41 and the end plate 54 are made integral by the left and right restraining members 55. Specifically, the battery module 40 including the battery stack 41, the pair of end plates 54, and the four restraining members 55 is completed.

Furthermore, the battery module 40 includes plural bus bars (not illustrated) which are connected to the positive electrode and the negative electrode of each battery cell 43.

As shown in FIGS. 1 and 2, each battery module 40 is housed in the interior of the lower case 24, and each battery module 40 is fixed to the bottom plate part 26. Specifically, a liquid-form heat conductive material 60, which is adhesive, is respectively applied to two left and right regions of the upper surface of the bottom plate part 26 extending in the front-rear direction. The heat conductive material 60 is, for example, an epoxy resin-based adhesive, a silicone rubber-based adhesive, a polyethylene-based adhesive, or a fluororesin-based adhesive. The left-right dimensions of each of these regions are substantially the same as the left-right dimensions of the battery cell 43 (cell case 44), and the front-rear dimension of each region is substantially the same as the front-rear dimension of the battery module 40. Furthermore, the heat conductive material 60 is applied to the entire region. The thermal conductivity of the heat conductive material 60 is high. Specifically, the thermal conductivity of the heat conductive material 60 is higher than the thermal conductivity of the spacer 53.

As shown in FIG. 1, the bottom of the left battery module 40 is placed on the left heat conductive material 60, and the bottom of the right battery module 40 is placed on the right heat conductive material 60. As a result, as shown in FIG. 5, the bottom plate part 50 of the cell case 44 of each battery cell 43 contacts the heat conductive material 60. When the heat conductive material 60 solidifies, the battery modules 40 are affixed to the bottom plate part 26 by the heat conductive material 60. The Young's modulus of the solidified heat conductive material 60 is lower than the Young's modulus of the lower case 24 and the Young's modulus of the cell case 44, and the solidified heat conductive material 60 is deformable.

Furthermore, the end plate 54 of each battery module 40 is affixed to the bottom plate part 26 via a bracket (not illustrated) having an L-shaped cross-section and made of a metal.

Further, the outer peripheral flange 36 of the upper case 35 is placed on the entire upper surface of the outer peripheral flange 28 of the lower case 24 containing the two battery modules 40 via a sealing material (not shown), and the outer peripheral flange 28 and the outer peripheral flange 36 are affixed to each other. As a result, the battery pack 20 is completed. Furthermore, the battery case 22 of the completed battery pack 20 is supported by the vehicle body frame member of the vehicle.

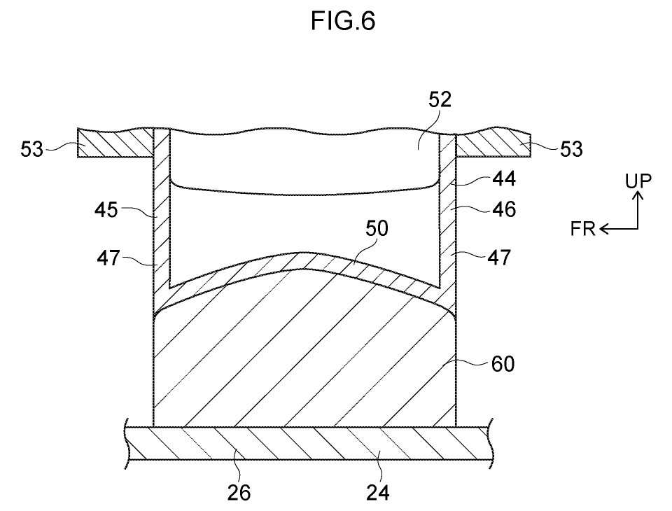

For example, when each battery cell 43 of each battery module 40 of the battery pack 20 installed in the vehicle is charged, as shown in FIG. 6, the bottom plate part 50 of the cell case 44 of each battery cell 43 is deformed so as to be recessed toward the internal space side of the cell case 44. While not shown, at this time, the upper plate part 51 of the cell case 44 is also deformed so as to be recessed toward the internal space side of the cell case 44. That is, the shapes of the bottom plate part 50 and the upper plate part 51 of each cell case 44 change.

Incidentally, as described above, when each restraining member 55 draws the front and rear end plates 54 together, each spacer 53 applies a force to the central part in the vertical direction of the front plate part 45 and the rear plate part 46 of the cell case 44, and as a result, the bottom plate part 50 protrudes downward as compared to when it is in a free state. However, as discussed above, the area of the portion of the spacer 53 which contacts the front plate part 45 or the rear plate part 46 (the portion which exerts a force on the front plate part 45 or the rear plate part 46) as viewed in the front-rear direction is smaller than the area of the front plate part 45 and the rear plate part 46, as a result of which, the upper part and the lower part of the front plate part 45 and the rear plate part 46 become non-pressure-receiving regions 47. When stress is generated in the front plate part 45 and the rear plate part 46, which have received the force from the spacer 53, the upper and lower non-pressure-receiving regions 47 serve as relief fields for stresses generated in the front plate part 45 and the rear plate part 46. As a result, stress transmitted from the front plate part 45 and the rear plate part 46 to the bottom plate part 50 (and the upper plate part 51) is reduced to the extent to which the stress in the upper and lower non-pressure-receiving regions 47 is relieved. Furthermore, the atmospheric pressure in the upper part (upper end part) and the lower part (lower end part) of the internal space of the cell case 44 is unlikely to increase, to the extent to which the stress is relieved in the upper and lower non-pressure-receiving regions 47. Specifically, the stress transmitted to the bottom plate part 50 (and the upper plate part 51) via the front plate part 45 and the rear plate part 46, and the atmospheric pressure in the upper part (upper end part) and the lower part (lower end part) of the internal space of the cell case 44 transmitted to the bottom plate part 50 (and the upper plate part 51), are unlikely to increase. As a result, the downward protuberance amount of the bottom plate part 50 is smaller than in a case in which the non-pressure-receiving regions 47 are not present in the front plate part 45 and the rear plate part 46. In other words, the bottom plate part 50 shown by a virtual line in FIG. 4 shows a deformation state of the bottom plate part 50 when each restraining member 55 draws the front and rear end plates 54 together in a case in which each spacer 53 contacts the whole vertical direction area of the front plate part 45 and the rear plate part 46 as shown by the imaginary line in FIG. 3. As is apparent from FIG. 4, the downward protuberance amount (deformation amount) of the bottom plate part 50 of the present embodiment is smaller than in a case in which each spacer 53 contacts the entire area of the front plate part 45 and the rear plate part 46 in the vertical direction.

As a result, while the bottom plate part 50 of the cell case 44 of the charged battery cell 43 deforms upward as shown in FIG. 6, the amount of deformation of the bottom plate part 50 of the present embodiment in the vertical direction between before charging and after charging is unlikely to be large. As a result, as compared to a case in which the amount of deformation of the bottom plate part 50 between before and after charging is large, there is a reduced possibility that the bottom plate part 50 of each battery cell 43 of the present embodiment will peel off from the solidified heat conductive material 60 during charging.

As a result, when the temperature of each battery cell 43 increases owing to the transfer of electric power between the electric motor and the battery module 40 after charging is completed, the heat of each battery cell 43 is efficiently transmitted from the bottom plate part 50 of the cell case 44 to the bottom plate part 26 via the heat conductive material 60. Furthermore, the heat of the bottom plate part 26 is absorbed by the cooler 38 via the heat conductive material 37.

Furthermore, the area of the spacer 53 (of the part in contact with the front plate part 45 or the rear plate part 46) as viewed in the front-rear direction is smaller than the area of the front plate part 45 and the rear plate part 46. Specifically, a calculated value, which is a value obtained by dividing the area of the spacer 53 by the area of the front plate part 45 and the rear plate part 46, is included in a predetermined appropriate range. The appropriate range is 0.15 to 0.90.

Note that in a case in which the calculated value is lower than the appropriate range, there is a possibility that the force exerted by the spacer 53 on the cell case 44 will be locally transmitted to the electrode body 52. In this case, lithium deposition is likely to occur at the electrode body 52. Further, if the calculated value is higher than the appropriate range, since, owing to the force exerted by the spacer 53 on the cell case 44, the amount of deformation of the end part of the side plate part 48 at the side of the bottom plate part 50 becomes easy to increase, the deformation amount of the bottom plate part 50 is likely to become large. In a case in which the calculated value is included in the appropriate range, such problems are unlikely to occur.

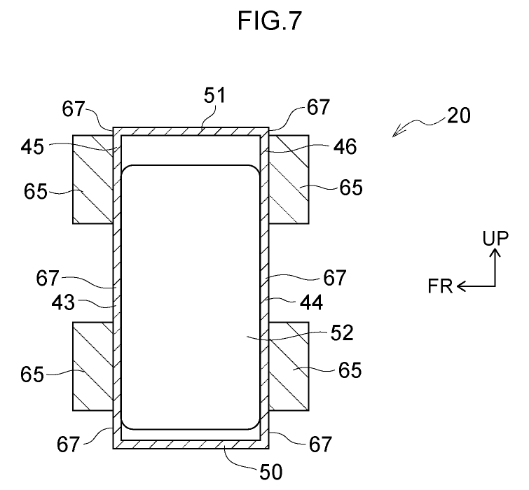

Next, a second embodiment of the present disclosure will be described with reference to FIG. 7. Note that the same members as in the first embodiment are denoted by the same reference numerals, and detailed description thereof will be omitted.

In the battery pack 20 of the second embodiment, the shape and the number of spacers 65 which contact the front plate part 45 and the rear plate part 46 of each battery cell 43 are different from those of the first embodiment.

As shown in FIG. 7, two spacers 65 aligned in the vertical direction contact the front plate part 45 and the rear plate part 46 of each cell case 44, respectively. The spacer 65 is an integral molded product made of a resin. The spacer 65 has a substantially rectangular parallelepiped shape. The left-right width of the spacer 65 is substantially the same as that of the battery cell 43, and the front-rear dimension of the spacer 65 is smaller than that of the cell case 44. Furthermore, the vertical dimension of the spacer 65 is smaller than that of the cell case 44 and of the spacer 53. Furthermore, three non-pressure-receiving regions 67 are formed at each of the front plate part 45 and the rear plate part 46. The total value of the areas of the two spacers 65 (the areas in contact with the front plate part 45 or the rear plate part 46) as viewed in the front-rear direction is smaller than the areas of the front plate part 45 and the rear plate part 46. The calculated value, which is the value obtained by dividing the total area of the two spacers 65 by the area of the front plate part 45 and the rear plate part 46, is included in the above-described appropriate range.

In the second embodiment, three non-pressure-receiving regions 67 are formed at each of the front plate part 45 and the rear plate part 46. As a result, when the restraining member 55 draws the front and rear end plates 54 together, when each spacer 65 applies a force to the front plate part 45 and the rear plate part 46 of the cell case 44, each non-pressure-receiving region 67 of the front plate part 45 and the rear plate part 46 becomes a relief field for stress generated in the front plate part 45 and the rear plate part 46. The number of non-pressure-receiving regions 67 of the front plate part 45 and the rear plate part 46 is greater than that of the first embodiment, and a non-pressure-receiving region 67 is formed at the vertically central part of the front plate part 45 and the rear plate part 46. The vertically central part of the front plate part 45 and the rear plate part 46 is more easily to be deformed than the upper end part and the lower end part. As a result, as compared to the first embodiment, the non-pressure-receiving region 67 of the front plate part 45 and the rear plate part 46 of the present embodiment can more easily relieve stress in the front plate part 45 and the rear plate part 46 when the restraining members 55 draw the front and rear end plates 54 together. As a result, the downward protuberance amount of the bottom plate part 50 of the present embodiment is smaller than the downward protuberance amount of the bottom plate part 50 of the first embodiment. As a result, during charging, the bottom plate part 50 of each battery cell 43 is unlikely to peel off from the solidified heat conductive material 60.

In this specification, "the central part, in the vertical direction, of the front plate part 45 and the rear plate part 46" is a region from which a region of 1/n from the upper end, and a region of 1/n from the lower end, of the front plate part 45 and the rear plate part 46 are excluded. This "n" is, for example, "5". However, "n" may be any of 3, 4, 6, 7, or 8.

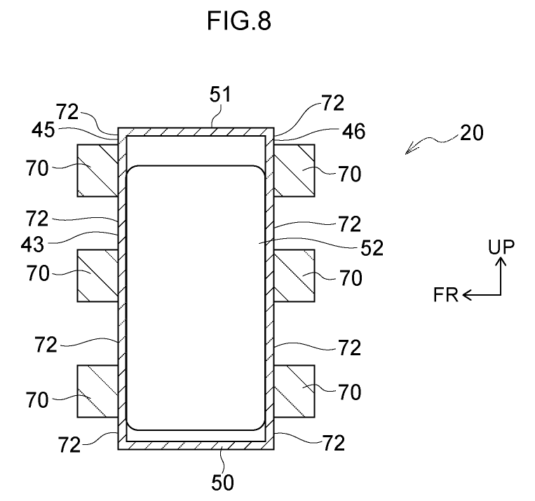

Next, a third embodiment of the present disclosure will be described with reference to FIG. 8. Note that the same members as in the first embodiment are denoted by the same reference numerals, and detailed description thereof will be omitted.

In the battery pack 20 of the third embodiment, the shape and the number of spacers 70 which contact the front plate part 45 and the rear plate part 46 of each battery cell 43 are different from those of the first embodiment.

As shown in FIG. 8, three spacers 70 aligned in the vertical direction contact the front plate part 45 and the rear plate part 46 of each cell case 44, respectively. The spacer 70 is an integral molded product made of a resin. The spacer 70 has a substantially rectangular parallelepiped shape. The left-right width of the spacer 70 is substantially the same as that of the battery cell 43, and the front-rear dimension of the spacer 70 is smaller than that of the cell case 44. Furthermore, the vertical dimension of the spacer 70 is smaller than that of the cell case 44 and of the spacer 65. Furthermore, four non-pressure-receiving regions 72 are formed at each of the front plate part 45 and the rear plate part 46. The two non-pressure-receiving regions 72 other than the uppermost non-pressure-receiving region 72 and the lowermost non-pressure-receiving region 72 are positioned at the central part, in the vertical direction, of the front plate part 45 and the rear plate part 46. The total value of the areas (of the parts in contact with the front plate part 45 or the rear plate part 46) of the three spacers 70 as viewed in the front-rear direction is smaller than the areas of the front plate part 45 and the rear plate part 46. The calculated value, which is the value obtained by dividing the total area of the three spacers 70 by the area of the front plate part 45 and the rear plate part 46, is included in the above-described appropriate range.

In the third embodiment, four non-pressure-receiving regions 72 are formed at each of the front plate part 45 and the rear plate part 46. As a result, when the restraining member 55 draws the front and rear end plates 54 together, when each spacer 70 applies a force to the front plate part 45 and the rear plate part 46 of the cell case 44, each of the non-pressure-receiving regions 72 of the front plate part 45 and the rear plate part 46 becomes a relief field for stress generated at the front plate part 45 and the rear plate part 46. Furthermore, two non-pressure-receiving regions 72 are positioned at the central part, in the vertical direction, of the front plate part 45 and the rear plate part 46. As a result, the downward protuberance amount of the bottom plate part 50 of the present embodiment is smaller than the downward protuberance amount of the bottom plate part 50 of the first embodiment. As a result, during charging, the bottom plate part 50 of each battery cell 43 is unlikely to peel off from the solidified heat conductive material 60.

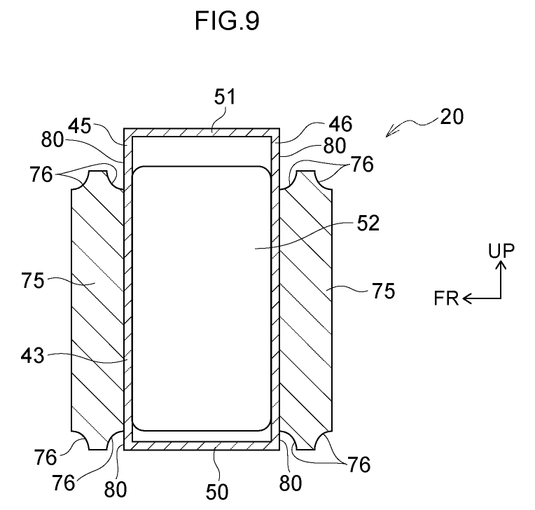

Next, a fourth embodiment of the present disclosure will be described with reference to FIG. 9. Note that the same members as in the first embodiment are denoted by the same reference numerals, and detailed description thereof will be omitted.

In the battery pack 20 of the fourth embodiment, the shape of the spacer 75 which contacts the front plate part 45 and the rear plate part 46 of each battery cell 43 is different from that of the first embodiment.

As shown in FIG. 9, one spacer 75 contacts the front plate part 45 and the rear plate part 46 of each cell case 44. The spacer 75 is an integral molded product made of a resin. The spacer 75 has a substantially rectangular parallelepiped shape. However, at respective side parts of the upper end part and the lower end part of the spacer 75, a cutout part 76 having a substantially arcuate cross-sectional shape (front shape) is provided. The left-right width of the spacer 75 is substantially the same as that of the battery cell 43, and the front-rear dimension of the spacer 75 is smaller than that of the cell case 44. Furthermore, the vertical dimension of the spacer 75 is smaller than that of the cell case 44 and larger than that of the spacer 53. Furthermore, two non-pressure-receiving regions 80 are formed at the upper end part and the lower end part of the front plate part 45 and the rear plate part 46. The area of the part of the spacer 75 which contacts the front plate part 45 or the rear plate part 46 as viewed in the front-rear direction is smaller than the area of the front plate part 45 and the rear plate part 46. A calculated value, which is a value obtained by dividing the area of the part of the spacer 75 which contacts the front plate part 45 or the rear plate part 46 by the area of the front plate part 45 and the rear plate part 46, is included in the above-described appropriate range.

In the fourth embodiment, the non-pressure-receiving regions 80 are formed at the upper end part and the lower end part of the front plate part 45 and the rear plate part 46. As a result, when the restraining member 55 draws the front and rear end plates 54 together, when each spacer 75 applies a force to the front plate part 45 and the rear plate part 46 of the cell case 44, the non-pressure-receiving regions 80 of the front plate part 45 and the rear plate part 46 become relief fields for stress generated at the front plate part 45 and the rear plate part 46. As a result, during charging, the bottom plate part 50 of each battery cell 43 is unlikely to peel off from the solidified heat conductive material 60.

Furthermore, the spacer 75 is positioned between the entire portion, other than the upper end part, of the front plate part 45 and the entire portion, other than the upper end part, of the rear plate part 46 of adjacent battery cells 43. As a result, the spacer 75 can more easily prevent short circuiting between adjacent battery cells 43, and further, prevent heat from moving between adjacent battery cells 43, than the spacers 53, 65, 70.

While battery packs according to respective embodiments have been described above, these can be appropriately modified in design within a range that does not depart from the gist of the present disclosure.

For example, any number of battery cells may be included in the battery module as long as it is a plural number.

Other members may be interposed between the battery cell 43 and the spacers 53, 65, 70, 75.

As shown in FIG. 3, the spacer 53 may have a thin-walled part 53A which contacts each non-pressure-receiving region. The thin-walled part 53A does not substantially exert a force on the front plate part 45 and the rear plate part 46 of the cell case 44, which are in contact therewith. However, the spacer 53 provided with the thin-walled part 53A can more effectively exhibit heat insulation and electrical insulation. While not shown in the drawings, the respective spacers 65, 70, 75 of FIGS. 7 - 9 may have a thin-walled part which contacts each non-pressure-receiving area 67, 72, 80 and which does not substantially exert a force on the front plate part 45 and the rear plate part 46.

The vehicle may be an electric vehicle which is different from a battery electric vehicle and which is provided with an electric motor which utilizes the power of the battery pack. For example, the vehicle may be a hybrid vehicle (HEV: Hybrid Electric Vehicle) or a plug-in hybrid vehicle (PHEV: Plug-in Hybrid Electric Vehicle).

What is claimed is:

1. A power storage device, comprising:
a plurality of battery cells having a cell case accommodating an electrode body and provided aligned in a predetermined first direction;
a spacer provided between adjacent battery cells of the battery cells, and exerting force on the cell case in the first direction;
a restraining member exerting an external force on the battery cells and the spacer;
a battery case accommodating a battery module having the battery cells, the spacer and the restraining member;
a cooler connected to the battery case; and
a heat conductive member that is adhered to the cell case and the battery case and that transmits heat from the cell case to the cooler via the battery case, wherein:
the cell case has:
a first plate part that receives force from the spacer in the first direction, and
a second plate part that contacts the heat conductive member in a second direction orthogonal to the first direction, and
an area of a portion of the spacer that exerts force on the first plate part, as viewed along the first direction, is smaller than an area of the first plate part.

2. The power storage device of claim 1, wherein the cell case is a rectangular parallelopiped-shaped case having a pair of first plate parts, the second plate part, which is connected to one end part of the pair of first plate parts in the second direction, a third plate part connected to another end part of the pair of first plate parts in the second direction, and a pair of fourth plate parts connected to the first plate parts, the second plate part and the third plate part and orthogonal to the first plate parts, the second plate part and the third plate part.

3. The power storage device of claim 1, wherein the spacer exerts force on the first plate part while avoiding an end part of the first plate part at a side of the second plate part.

4. The power storage device of claim 1, wherein the spacer, which is a single spacer, exerts force on the first plate part while avoiding both end parts of the first plate part in the second direction.

5. The power storage device of claim 1, wherein a plurality of the spacers, which are aligned at an interval in the second direction, exert force on a single one of the first plate parts while avoiding a central part of the first plate part in the second direction.
